(19) United States
(12) Patent Application Publication
(10) Pub. No.: US 2026/0097654 A1
(43) Pub. Date: Apr. 9, 2026

(54) SIGHT-LINE GUIDANCE APPARATUS, SIGHT-LINE GUIDANCE METHOD, AND RECORDING MEDIUM

(71) Applicant: HONDA MOTOR CO., LTD., Tokyo (JP)

(72) Inventors: Toshihiro Hashimoto, Wako-shi (JP); Yuichiro Shimura, Wako-shi (JP)

(21) Appl. No.: 19/343,853

(22) Filed: Sep. 29, 2025

(30) Foreign Application Priority Data
Oct. 9, 2024 (JP) 2024-177069

(51) Int. Cl. B60K 35/28; B60K 35/23

(52) U.S. Cl. CPC B60K 35/285; B60K 35/23; B60K 2360/1868; B60K 2360/785

(57) ABSTRACT

A sight-line guidance apparatus is a sight-line guidance apparatus that guides a line of sight of a driver of a vehicle, and includes: a detection unit that detects a target existing in front of the vehicle; and a display control unit that displays a sight-line guidance sign on a windshield of the vehicle when the detection unit detects the target. The sight-line guidance sign guides the line of sight of the driver to the target. The display control unit displays the sight-line guidance sign in such a manner that the sight-line guidance sign moves from a display start position of the sight-line guidance sign toward the target in accordance with a change in movement speed. The change is made according to a type of the target.

### INCORPORATION BY REFERENCE

The present application claims priority under 35 U.S.C. § 119 to Japanese Patent Application No.2024-177069 filed on Oct. 9, 2024. The content of the application is incorporated herein by reference in its entirety.

### BACKGROUND OF THE INVENTION

### Field of the Invention

The present invention relates to a sight-line guidance apparatus, a sight-line guidance method, and a recording medium.

### Description of the Related Art

In recent years, research and development related to the visibility of a vehicle driver has been conducted to be able to contribute to further improvement in traffic safety and development of sustainable transportation systems. Conventionally, there has been known a technology of guiding the line of sight of a vehicle driver, as a technology related to the visibility of a vehicle driver. For example, Japanese Patent Laid-Open No. 2017-187955 discloses a sight-line guidance apparatus that guides the line of sight of a driver toward a target by moving a vision stimulus displayed on a windshield. Japanese Patent Laid-Open No. 2017-187955 also discloses that moving speed at which the vision stimulus is moved is increased as an angle formed by the target and the line of sight increases.

According to Japanese Patent Laid-Open No. 2017-187955, a configuration is made such that a similar time period is used to move the vision stimulus to the target, regardless of the distance between the point of sight of the driver and the target. Accordingly, with the configuration of Japanese Patent Laid-Open No. 2017-187955, there is a possibility that it can be perceived, only from a result of movement of the vision stimulus, what is the target to which the line of sight is intended to be guided, so that there is a possibility that the driver cannot easily perceive what target the vision stimulus intends to guide the line of sight to.

Accordingly, the present invention has been made in view of the circumstances as described above, and an object thereof is to make it possible for a driver to easily perceive what target the line of sight is intended to be guided to.

### SUMMARY OF THE INVENTION

An aspect of the present invention is a sight-line guidance apparatus that guides a line of sight of a driver of a vehicle, including: a detection unit that detects a target existing in front of the vehicle; and a display control unit that displays a sight-line guidance sign on a windshield of the vehicle when the detection unit detects the target, the sight-line guidance sign guiding the line of sight of the driver to the target, wherein the display control unit displays the sight-line guidance sign in such a manner that the sight-line guidance sign moves from a display start position of the sight-line guidance sign toward the target in accordance with a change in movement speed, the change being made according to a type of the target.

According to the aspect of the present invention, a driver can easily perceive what target the line of sight is intended to be guided to.

### BRIEF DESCRIPTION OF THE DRAWINGS

FIG. 1 shows a configuration in a vehicle cabin of a vehicle;

FIG. 2 shows a configuration of the vehicle;

FIG. 3 is a diagram for describing processing by a display control unit;

FIG. 4 is a diagram for describing determination of a second movement end position;

FIG. 5 is a chart for describing changes in movement speed in a first mode;

FIG. 6 shows an example of movement of a sight-line guidance sign;

FIG. 7 is a chart for describing changes in movement speed in a second mode;

FIG. 8 shows an example of movement of the sight-line guidance sign;

FIG. 9 is a chart for describing changes in movement speed in a third mode;

FIG. 10 shows an example of movement of the sight-line guidance sign;

FIG. 11 shows an example of movement of the sight-line guidance sign; and

FIG. 12 is a flowchart showing operation of a sight-line guidance apparatus.

### DETAILED DESCRIPTION OF THE INVENTION

### 1. Configuration of Vehicle

Hereinafter, an embodiment will be described with reference to the drawings.

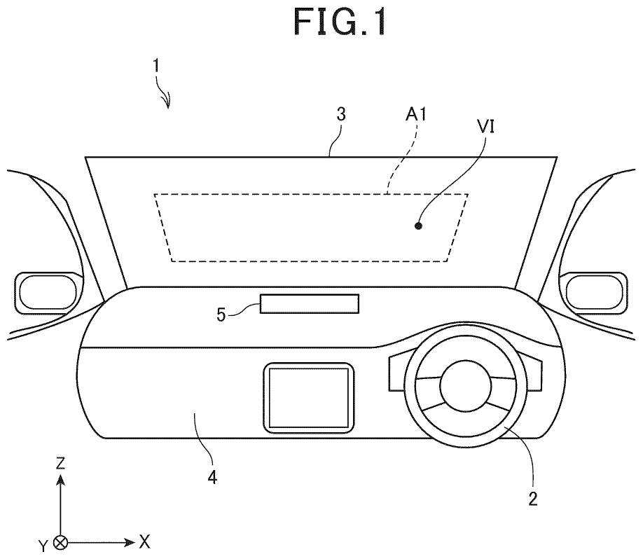

In FIGS. 1, 3, 4, 6, 8, 10, and 11, an X-axis, a Y-axis, and a Z-axis are shown. The X-axis, the Y-axis, and the Z-axis are orthogonal to each other. The Z-axis indicates an up-down direction. The X-axis and the Y-axis are parallel to a horizontal direction in a state where a vehicle 1 is traveling. The X-axis indicates a right-left direction as a vehicle width direction. The Y-axis indicates a front-rear direction. A positive direction of the X-axis indicates a rightward direction. A positive direction of the Y-axis indicates a forward direction. A positive direction of the Z-axis indicates an upward direction.

FIG. 1 shows a configuration in a vehicle cabin of the vehicle 1.

For the vehicle 1 in the present embodiment, a four-wheel automobile is illustrated.

In the vehicle cabin of the vehicle 1, a steering wheel 2 for steering the vehicle 1, a windshield 3 that separates the inside of the vehicle cabin from the outside, and an instrument panel 4 are installed. The steering wheel 2 is installed in the instrument panel 4 at a position facing a driver U sitting in a driver seat.

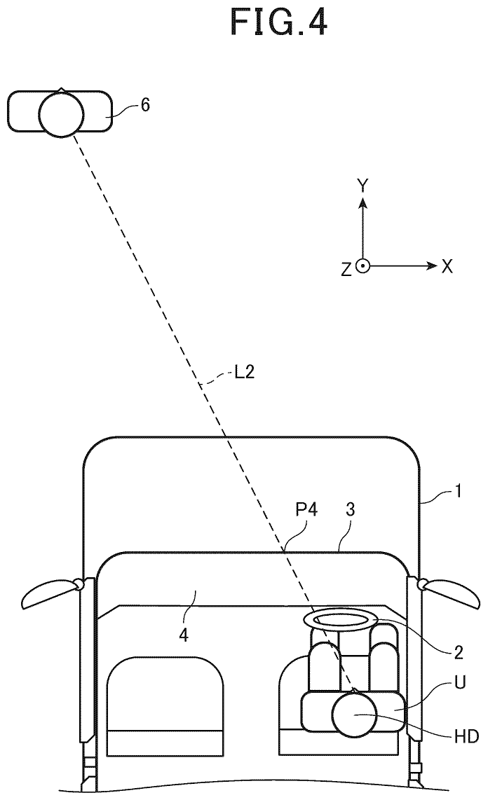

A HUD (Head Up Display) 5 is provided in the instrument panel 4. The HUD 5 displays a sight-line guidance sign VI that guides the line of sight of the driver U (see FIG. 4) to a target 6 (for example, see FIG. 4) by projecting light onto the windshield 3. The sight-line guidance sign VI is a virtual image. The target 6 refers to a target object to which it is preferable to direct the line of sight of the driver U. The HUD 5 displays the sight-line guidance sign VI on the windshield 3, whereby the driver U sitting in the driver seat can see the sight-line guidance sign VI together with a scene in front of the vehicle 1 through the windshield 3.

Note that FIG. 1 illustrates a circle as a shape of the sight-line guidance sign VI. However, the shape of the sight-line guidance sign VI shown in FIG. 1 is only an example, and may also be, for example, a rectangle or a star shape.

In FIG. 1, a display-allowed area A1 in which the sight-line guidance sign VI can be displayed is depicted by a dotted line. The size of the display-allowed area A1 corresponds to the size of a magnifying mirror (concave mirror) included in the HUD 5. Note that the size of the display-allowed area A1 relative to the windshield 3 is not limited to the size shown in FIG. 1. Moreover, although FIG. 1 shows such a shape that the longer-side direction of the display-allowed area A1 is the vehicle width direction, the shape of the display-allowed area A1 is not limited to the shape shown in FIG. 1.

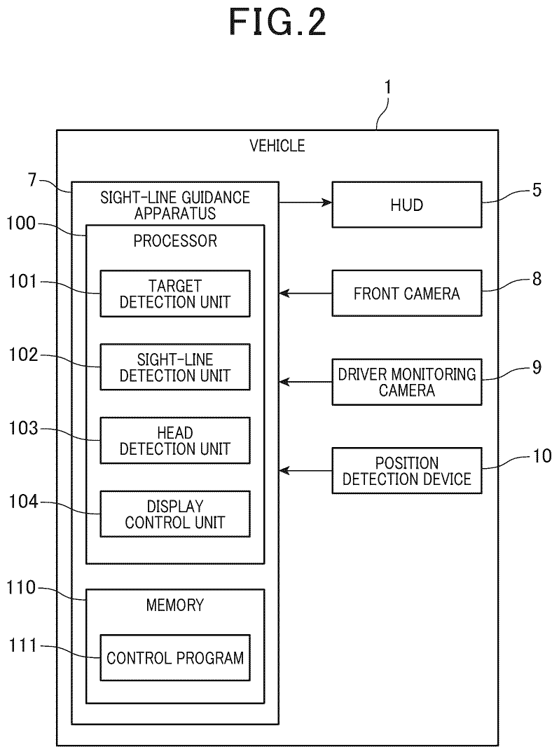

FIG. 2 shows a configuration of the vehicle 1.

The vehicle 1 includes a sight-line guidance apparatus 7. The sight-line guidance apparatus 7 includes a processor 100, such as a CPU (Central Processing Unit) or an MPU (Micro-Processing Unit), and memory 110.

The processor 100 controls each unit of the sight-line guidance apparatus 7 by reading and executing a control program 111 stored in the memory 110. The processor 100 functions as a target detection unit 101, a sight-line detection unit 102, a head detection unit 103, and a display control unit 104 by executing the control program 111 stored in the memory 110.

The target detection unit 101 is an example of “detection unit”.

The memory 110 is a storage device that stores a program to be executed by the processor 100 and data to be processed by the processor 100. The memory 110 stores the control program 111 to be executed by the processor 100 and other various data. The memory 110 includes a non-volatile storage area. Moreover, the memory 110 includes a volatile storage area, which constitutes a work area for the processor 100. The memory 110 is configured by using, for example, a ROM (Read Only Memory) and a RAM (Random Access Memory).

The control program 111 corresponds to “program”.

The HUD 5, a front camera 8, a driver monitoring camera 9, and a position detection device 10 are connected to the sight-line guidance apparatus 7. Note that devices connected to the sight-line guidance apparatus 7 are not limited to those mentioned above, and a vehicle-to-vehicle communication apparatus for vehicle-to-vehicle communication and other devices, such as a GNSS (Global Navigation Satellite System) unit, a rear camera, and a vehicle speed sensor, may be connected.

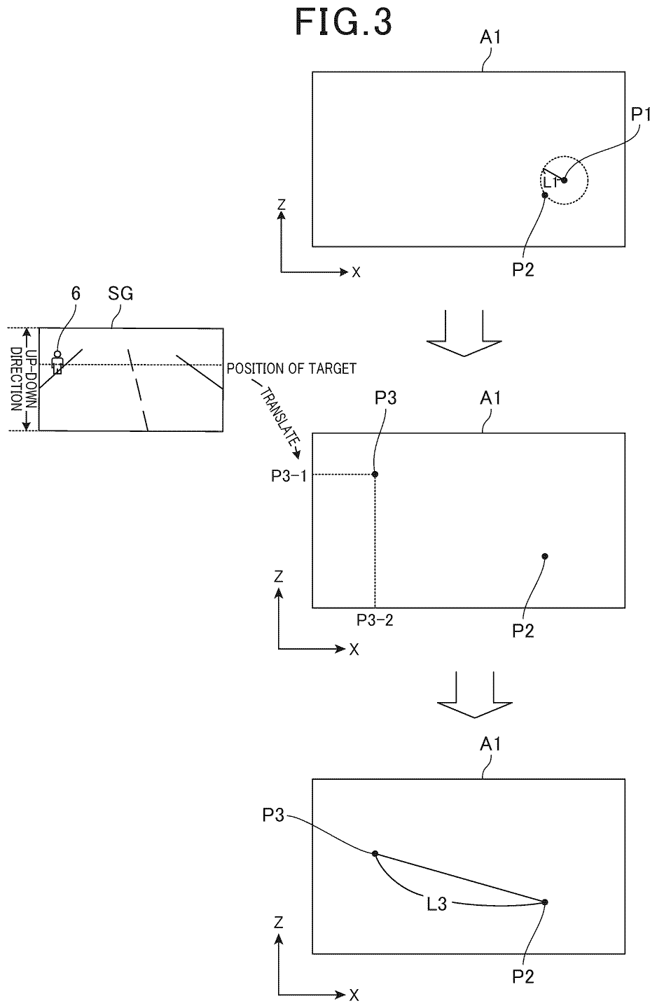

The front camera 8 is a camera installed at a predetermined position in the vehicle 1 and capturing a scene in front of the vehicle 1. The front camera 8 performs capturing in each predetermined period when an ignition of the vehicle 1 is on, when an accessory power supply of the vehicle 1 is on, or the like. Each time the front camera 8 performs capturing, the front camera 8 outputs image data on a captured image SG (see FIG. 3) acquired by the capturing to the sight-line guidance apparatus 7.

The driver monitoring camera 9 is a camera installed at a predetermined position in the vehicle cabin of the vehicle 1 and capturing the driver U sitting in the driver seat. The capturing range of the driver monitoring camera 9 is a range including at least a head HD (see FIG. 4) of the driver U sitting in the driver seat. The driver monitoring camera 9 performs capturing in each predetermined period when the ignition of the vehicle 1 is on, when the accessory power supply of the vehicle 1 is on, or the like. Each time the driver monitoring camera 9 performs capturing, the driver monitoring camera 9 outputs image data on a captured image acquired by the capturing to the sight-line guidance apparatus 7.

The position detection device 10 is a device that can detect a position of an object existing around the vehicle 1. The position detection device 10 is configured by using at least one or more of, for example, a sonar, a radar, lidar, all of which can measure the distance between the vehicle 1 and the object, a stereo camera, which can measure the distance between the vehicle 1 and the object by using parallax, and the like.

As mentioned above, the processor 100 of the sight-line guidance apparatus 7 functions as the target detection unit 101, the sight-line detection unit 102, the head detection unit 103, and the display control unit 104.

### 1-1. Target Detection Unit

The target detection unit 101 detects a target 6 existing in front of the vehicle 1. The target detection unit 101 detects the target 6 appearing in a captured image SG acquired by capturing by the front camera 8, based on image data on the captured image SG received from the front camera 8. As mentioned above, the target 6 refers to a target object to which the line of sight of the driver U should be directed. In the present embodiment, the target 6 is any one of a pedestrian, a passenger car, a motorcycle, a bicycle, a trailer, and a fixed object. Pedestrians include children. Examples of the fixed object include road signs, delineators, and the like. The target detection unit 101 detects the target 6 appearing in the captured image SG by performing pattern matching or color-based image processing on the captured image SG. Note that data (for example, shape data or color data) required to detect the target 6 is stored in the memory 110 for each of pedestrian, passenger car, motorcycle, bicycle, trailer, and fixed object.

Moreover, the target detection unit 101 detects a position of the detected target 6. More specifically, the target detection unit 101 detects the relative position of the detected target 6 with respect to the vehicle 1 when the vehicle 1 is viewed from above. The target detection unit 101 detects the relative position of the detected target 6, based on at least any one of a result of detection by the position detection device 10 and the captured image SG from the front camera 8. Note that when the detected target 6 is another vehicle and when a vehicle-to-vehicle communication apparatus and a GNSS unit are connected to the sight-line guidance apparatus 7, the target detection unit 101 may detect the relative position of the detected target 6, based on the position of the other vehicle received by the vehicle-to-vehicle communication apparatus and the position of the vehicle 1 received by the GNSS unit.

Note that apart from the front camera 8, the vehicle-to-vehicle communication apparatus, and the GNSS unit, the target detection unit 101 may use V2X (road-to-vehicle, vehicle-to-pedestrian, or the like) communication, determination in a virtual environment via a server, or the like to detect the target 6 appearing in the captured image SG and to detect the relative position of the target 6.

When the target 6 is detected, the target detection unit 101 outputs data indicating the type of the detected target 6, data indicating the relative position of the detected target 6 with respect to the vehicle 1, and data indicating a position of the detected target 6 in the captured image to the display control unit 104.

### 1-2. Sight-Line Detection Unit

The sight-line detection unit 102 detects the direction of the line of sight of the driver U. The sight-line detection unit 102 detects the direction of the line of sight of the driver U, based on image data on a captured image received from the driver monitoring camera 9. The sight-line detection unit 102 detects the eyes of the driver U, through pattern matching or based on color or the like, from the captured image acquired by capturing by the driver monitoring camera 9, and detects a direction in which the detected eyes are pointing as the direction of the line of sight. Note that data (for example, eye shape data or color data) required to detect an eye is stored in the memory 110.

When the direction of the line of sight of the driver U is detected, the sight-line detection unit 102 outputs data indicating the detected direction of the line of sight to the display control unit 104.

### 1-3. Head Detection Unit

The head detection unit 103 detects the head HD of the driver U sitting in the driver seat. The head detection unit 103 detects the head HD of the driver U, based on image data on a captured image received from the driver monitoring camera 9. The head detection unit 103 detects the head HD, through pattern matching or based on color or the like, from the captured image acquired by capturing by the driver monitoring camera 9. Next, the head detection unit 103 detects a position of the head HD in the captured image. The head detection unit 103 then detects a position of the head HD in the vehicle 1 when the vehicle 1 is viewed from above, based on the size of the head HD appearing in the captured image and the position of the head HD in the captured image. Note that it has been determined, through testing or simulation performed beforehand, what position the head HD is at in the vehicle 1 when how big the head HD is in a captured image and what position the head HD is at in the captured image, and such information is stored as data in the memory 110.

### 1-4. Display Control Unit

The display control unit 104 displays a sight-line guidance sign VI on the windshield 3 by controlling operation of the HUD 5. The display control unit 104 displays the sight-line guidance sign VI on the windshield 3 and, in the windshield 3, moves the sight-line guidance sign VI displayed on the windshield 3, by performing following processing.

The processing by the display control unit 104 is described with reference to FIG. 3.

FIG. 3 is a diagram for describing the processing by the display control unit 104.

The display control unit 104 detects a position of the line of sight (hereinafter, referred to as “sight-line position P1” with sign “P1” added) of the driver U in the windshield 3, based on the direction of the line of sight indicated by data received from the sight-line detection unit 102. For example, when the memory 110 stores data on the directions of the lines of sight of drivers U and sight-line positions P1 of the drivers U in the windshield 3 that are associated with each other, the display control unit 104 detects the sight-line position P1 of the driver U in the windshield 3 by referring to the data.

The display control unit 104 determines whether the detected sight-line position P1 of the driver U exists within the display-allowed area A1. The memory 110 stores data indicating the position of the display-allowed area A1 in the windshield 3. The display control unit 104 determines whether the detected sight-line position P1 of the driver U exists within the display-allowed area A1 by referring to the data stored in the memory 110.

When the display control unit 104 determines that the detected sight-line position P1 of the driver U exists within the display-allowed area A1, the display control unit 104 determines, as a display start position P2 of the sight-line guidance sign VI, a position that is a predetermined distance L1 away from the sight-line position P1 of the driver U, as shown in FIG. 3. Note that the display control unit 104 determines the display start position P2 by loading, into the memory 110, a coordinate system in which the shape, size, and up-down, right-left directions of the display-allowed area A1 are defined, and referring to the loaded coordinate system.

It is preferable that the predetermined distance L1 be a distance that positions the display start position P2 within a range including a central visual field centered on the sight-line position P1. For example, the predetermined distance L1 is a distance that positions the display start position P2 at a position on a circle that satisfies a vertical visual field of five degrees and a horizontal visual field of five degrees from the line of sight of the driver U. Note that the position on the circle that satisfies the vertical visual field of five degrees and the horizontal visual field of five degrees from the line of sight of the driver U is a position within the range of an effective visual field centered on the sight-line position P1. Although FIG. 3 illustrates a configuration in which the display start position P2 below and to the left of the sight-line position P1 is determined, the position of the display start position P2 may be, for example, below and to the right of the sight-line position P1, above and to the right of the sight-line position P1, or above and to the left of the sight-line position P1.

When the display start position P2 is determined, the display control unit 104 determines a movement end position P3 of the sight-line guidance sign VI. Note that the display control unit 104 determines the movement end position P3 by loading, into the memory 110, a coordinate system in which the shape, size, and up-down, right-left directions of the display-allowed area A1 are defined, and referring to the loaded coordinate system.

In the determination of the movement end position P3, the display control unit 104 determines a movement end position P3 in the up-down direction of the display-allowed area A1 (hereinafter, referred to as “first movement end position P3-1″ with sign ”P3-1″ added).

Note that the up-down direction of the display-allowed area A1 corresponds to the up-down direction of the windshield 3 and the shorter-side direction of the display-allowed area A1.

Moreover, in the determination of the movement end position P3, the display control unit 104 determines a movement end position P3 in the right-left direction of the display-allowed area A1 (hereinafter, referred to as “second movement end position P3-2″ with sign ”P3-2″ added). Note that the right-left direction of the display-allowed area A1 corresponds to the right-left direction of the windshield 3 and the longer-side direction of the display-allowed area A1.

First, the determination of the first movement end position P3-1 is described.

The display control unit 104 obtains a position of the target 6 in the up-down direction of a captured image SG from data outputted by the target detection unit 101. The up-down direction of the captured image SG is a direction corresponding to the up-down direction of a scene appearing in the captured image SG. Next, the display control unit 104 translates the obtained position of the target 6 into a position in the up-down direction of the display-allowed area A1, and determines that the position after the translation is the first movement end position P3-1. Note that the relationship between the position of the target 6 in the up-down direction of the captured image SG and the position in the up-down direction of the display-allowed area A1 has been obtained through a simulation or the like beforehand, and is stored as data in the memory 110.

Next, the determination of the second movement end position P3-2 is described.

The display control unit 104 determines the second movement end position P3-2, based on the detected relative position of the target 6 and the detected position of the head HD.

FIG. 4 is a diagram for describing the determination of the second movement end position P3-2.

FIG. 4 illustrates, as the target 6, a pedestrian existing in front of the vehicle 1.

The display control unit 104 detects, in a view of the vehicle 1 from above, a position where a line connecting the position of the head HD of the driver U and the position of the target 6 intersects with the windshield 3 in the right-left direction of the vehicle 1. The display control unit 104 detects the position in the right-left direction at which the line connecting the position of the head HD of the driver U and the position of the target 6 intersects with the windshield 3, based on the relative position of the target 6 detected by the target detection unit 101 and the position of the head HD of the driver U detected by the head detection unit 103.

In FIG. 4, a line L2 is the line connecting the position of the head HD of the driver U and the position of the pedestrian in the view of the vehicle 1 from above. In the case of FIG. 4, the display control unit 104 detects a position P4 in the right-left direction at which the line L2 in the right-left direction intersects with the windshield 3 in the view of the vehicle 1 from above.

Next, when the position of the intersection in the right-left direction is detected, the display control unit 104 determines that the detected position is the second movement end position P3-2 when the detected position is within the display-allowed area A1.

Returning to the description of the display control unit 104 with reference to FIG. 3, when the first movement end position P3-1 and the second movement end position P3-2 are determined, the display control unit 104 determines, as the movement end position P3, a position determined by the first movement end position P3-1 and the second movement end position P3-2.

After the display start position P2 and the movement end position P3 are determined, the display control unit 104 calculates a distance between the display start position P2 and the movement end position P3 in the windshield 3. The display control unit 104 calculates the distance between the display start position P2 and the movement end position P3 in the windshield 3 by obtaining a straight distance between the display start position P2 and the movement end position P3 on a coordinate system loaded into the memory 110, and translating the obtained distance into the distance in the windshield 3.

When the distance between the display start position P2 and the movement end position P3 in the windshield 3 is obtained, the display control unit 104 determines whether or not the obtained distance is a predetermined distance or more. As an example, the predetermined distance is 10 cm (centimeters), 20 cm, or the like.

### 1-4-1. Predetermined Distance or More

When the display control unit 104 determines that the distance between the display start position P2 and the movement end position P3 in the windshield 3 is the predetermined distance or more, the display control unit 104 decides on a mode of changing movement speed used when moving the sight-line guidance sign VI from the display start position P2 to the movement end position P3, according to the type of the detected target 6.

When the detected target 6 is a pedestrian, the display control unit 104 decides on a first mode, for the mode of changing the movement speed of the sight-line guidance sign VI.

The first mode is 1/f fluctuation.

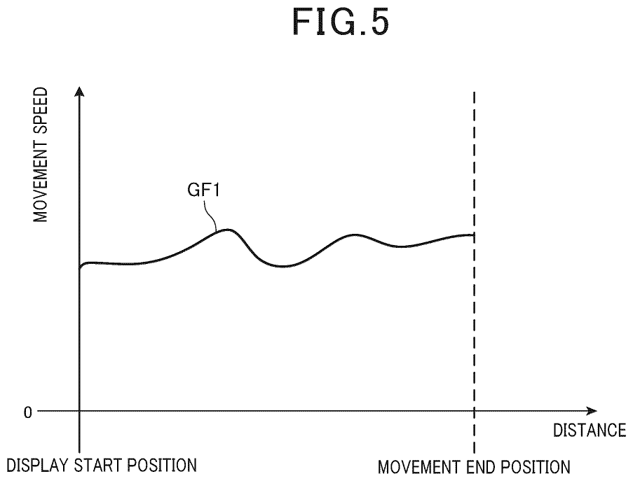

For example, changes in movement speed in the first mode present changes in movement speed shown in FIG. 5.

FIG. 5 is a chart for describing changes in movement speed in the first mode.

In FIG. 5, a vertical axis represents the movement speed of the sight-line guidance sign VI in the windshield 3. Moreover, in FIG. 5, a horizontal axis represents distance in the windshield 3 that is distance on a straight line starting from the display start position P2 and passing the movement end position P3.

In FIG. 5, a graph GF1 is depicted that shows an example of changes in movement speed against distances traveled from the display start position P2. As shown in graph GF1, changes in movement speed in the first mode are such changes that acceleration and deceleration are repeated at random in the movement from the display start position P2 to the movement end position P3.

When the first mode is decided for the mode of changing the movement speed of the sight-line guidance sign VI, the display control unit 104 linearly moves the sight-line guidance sign VI from the display start position P2 to the movement end position P3 in accordance with changes in movement speed in the first mode.

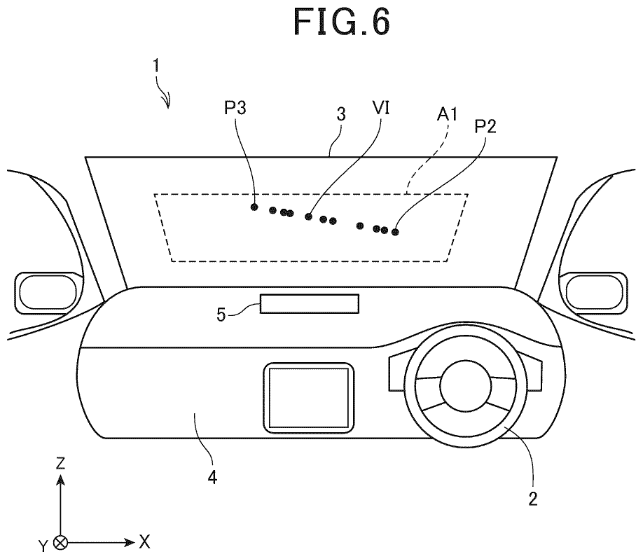

FIG. 6 shows an example of the movement of the sight-line guidance sign VI.

FIG. 6 shows a case in which the sight-line guidance sign VI is moved in accordance with changes in movement speed in the first mode.

In FIG. 6, each of black circles is the sight-line guidance sign VI. In FIG. 6, the plurality of black circles indicates the positions of the sight-line guidance sign VI, each in a unit time period, in the movement from the display start position P2 to the movement end position P3. As shown in FIG. 6, according to changes in movement speed in the first mode, the sight-line guidance sign VI repeats accelerating and decelerating at random a plurality of times, in the movement from the display start position P2 to the movement end position P3.

A pedestrian is more likely to make an unpredictable direction change, compared to a vehicle and a fixed object. Accordingly, it can be said that a pedestrian is a target 6 to which it is more necessary for the driver U to pay close attention, compared to a vehicle and a fixed object.

Accordingly, when the detected target 6 is a pedestrian as described above, the display control unit 104 moves the sight-line guidance sign VI in accordance with changes in movement speed in the first mode.

1/f fluctuation is said to be a type of biological movement. It is said that humans easily notice biological movements, and more easily notice movements with a higher degree of randomness. 1/f fluctuation presents biological movements, and has a higher degree of randomness than in a second mode, which will be described later.

Accordingly, when the detected target 6 is a pedestrian, the sight-line guidance apparatus 7 moves the sight-line guidance sign VI in accordance with changes in movement speed in the first mode. Accordingly, the driver U can easily perceive that the sight-line guidance sign VI intends to guide the line of sight to a pedestrian. Moreover, by changing the movement speed of the sight-line guidance sign VI in the first mode, since the driver U can quickly notice the sight-line guidance sign VI, the driver U can quickly perceive that the sight-line guidance sign VI intends to guide the line of sight to a pedestrian.

When the detected target 6 is any one of a passenger car, a motorcycle, and a bicycle (hereinafter, referred to as “passenger car or the like” as appropriate), the display control unit 104 decides on the second mode, for the mode of changing the movement speed of the sight-line guidance sign VI.

The second mode is a mode with a minimum jerk. More specifically, the second mode is a mode in which a change in acceleration rate is small at following three timings: when movement is started, when a switch is made from acceleration to deceleration, and when the movement is ended. Even more specifically, the second mode is a mode in which a change in acceleration rate at the three timings is smaller than in a third mode, which will be described later. Note that in the present embodiment, the meaning of a minimum jerk does not include a case in which a change in acceleration rate is zero.

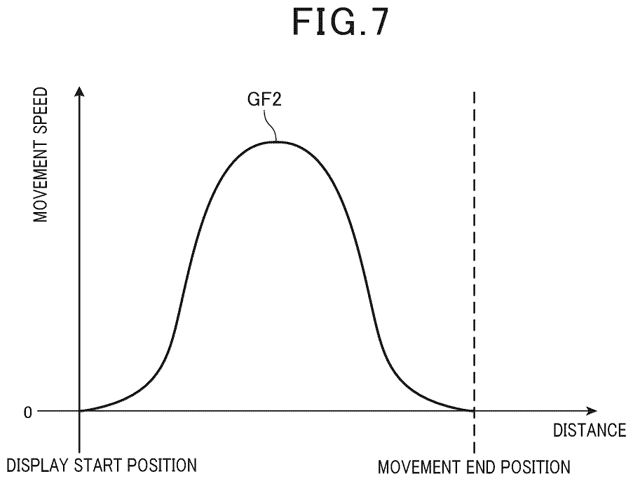

For example, changes in movement speed in the second mode present changes in movement speed shown in FIG. 7.

FIG. 7 is a chart for describing changes in movement speed in the second mode.

In FIG. 7, a vertical axis and a horizontal axis are the same as the vertical axis and the horizontal axis in FIG. 5.

In FIG. 7, a graph GF2 is depicted that shows an example of changes in movement speed against distances traveled from the display start position P2. As shown in graph GF2, changes in movement speed in the second mode are changes in a mode in which acceleration and deceleration are performed once for each from the start of movement until the end of the movement, and a change in acceleration rate made when movement is started, when a switch is made from acceleration to deceleration, and when the movement is ended is smaller than in the third mode. In other words, the changes in movement speed in the second mode are changes in a mode in which acceleration and deceleration are performed once for each from the start of movement until the end of the movement, and a change in movement speed made when movement is started, when a switch is made from acceleration to deceleration, and when the movement is ended is smoother than in the third mode.

When the second mode is decided for the mode of changing the movement speed of the sight-line guidance sign VI, the display control unit 104 linearly moves the sight-line guidance sign VI from the display start position P2 to the movement end position P3 in accordance with changes in movement speed in the second mode.

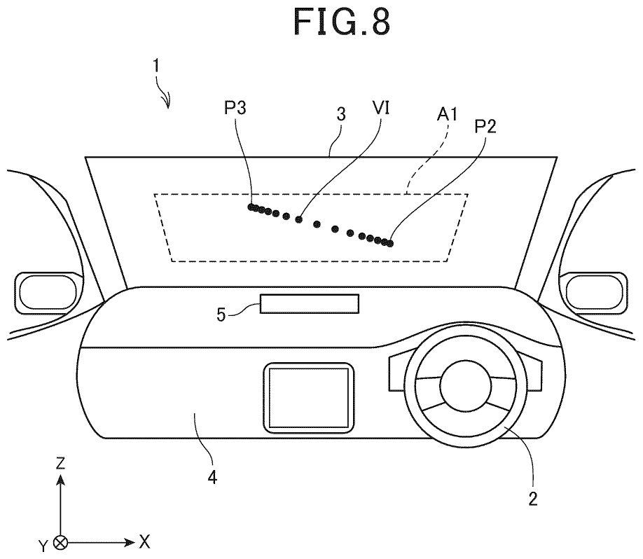

FIG. 8 shows an example of the movement of the sight-line guidance sign VI.

FIG. 8 shows a case in which the sight-line guidance sign VI is moved in accordance with changes in movement speed in the second mode.

In FIG. 8, each of black circles is the sight-line guidance sign VI. In FIG. 8, the plurality of black circles indicates the positions of the sight-line guidance sign VI, each in a unit time period, in the movement from the display start position P2 to the movement end position P3. As shown in FIG. 8, according to changes in movement speed in the second mode, the sight-line guidance sign VI starts moving by gradually accelerating, and the sight-line guidance sign VI ceases moving by gradually decelerating, in the movement from the display start position P2 to the movement end position P3.

A passenger car and the like can change direction to the right or left, but are less likely to make an abrupt direction change in forward and rearward directions, compared to a pedestrian. Accordingly, it can be said that a passenger car or the like is a target 6 to which it is less necessary for the driver U to pay close attention, compared to a pedestrian. On the other hand, compared to a trailer and a fixed object, the probability of which making an unpredictable direction change is slim, it can be said that a passenger car or the like is a target 6 to which it is more necessary for the driver U to pay close attention.

Accordingly, when the detected target 6 is any one of a passenger car and the like as described above, the display control unit 104 moves the sight-line guidance sign VI in accordance with changes in movement speed in the second mode.

Changes in speed with a minimum jerk are said to be a type of biological movement, and have a lower degree of randomness than in the first mode.

Accordingly, when the detected target 6 is any one of a passenger car and the like, the sight-line guidance apparatus 7 moves the sight-line guidance sign VI in accordance with changes in movement speed in the second mode that is different from the first mode. Accordingly, the driver U can easily perceive that the sight-line guidance sign VI intends to guide the line of sight to the target 6 that is any one of a passenger car and the like. Moreover, by changing the movement speed of the sight-line guidance sign VI in the second mode, since the driver U can quickly notice the sight-line guidance sign VI, the driver U can quickly perceive that the sight-line guidance sign VI intends to guide the line of sight to a passenger car or the like.

When the detected target 6 is a trailer or a fixed object, the display control unit 104 decides on the third mode, for the mode of changing the movement speed of the sight-line guidance sign VI.

The third mode is a mode of linearly accelerating and then linearly decelerating.

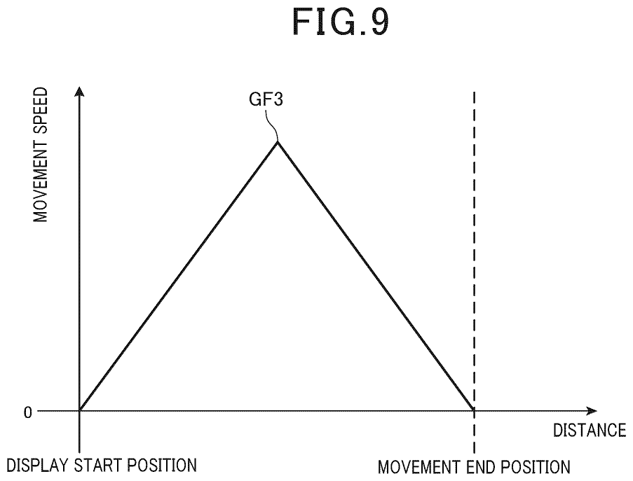

For example, changes in movement speed in the third mode present changes in movement speed shown in FIG. 9.

FIG. 9 is a chart for describing changes in movement speed in the third mode.

In FIG. 9, a vertical axis and a horizontal axis are the same as the vertical axis and the horizontal axis in FIG. 5.

In FIG. 9, a graph GF3 is depicted that shows an example of changes in movement speed against distances traveled from the display start position P2. As shown in graph GF3, changes in movement speed in the third mode are changes in a mode in which acceleration and deceleration are linearly performed once for each from the start of movement until the end of the movement, and a change in acceleration rate made when movement is started, when a switch is made from acceleration to deceleration, and when the movement is ended is larger than in the second mode.

When the third mode is decided for the mode of changing the movement speed of the sight-line guidance sign VI, the display control unit 104 linearly moves the sight-line guidance sign VI from the display start position P2 to the movement end position P3 in accordance with changes in movement speed in the third mode.

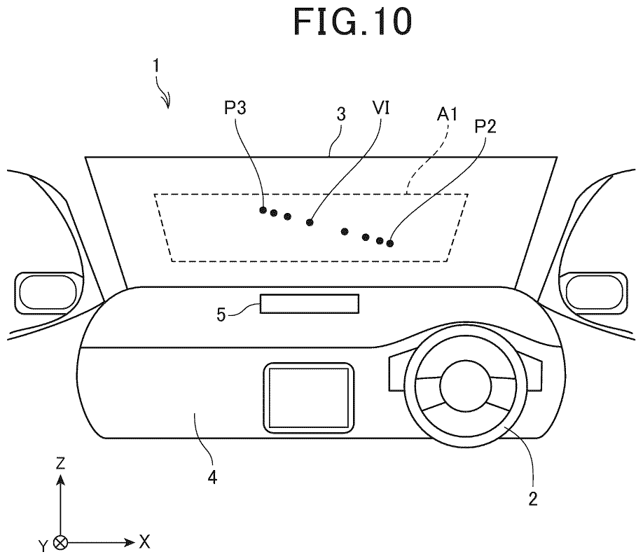

FIG. 10 shows an example of the movement of the sight-line guidance sign VI.

FIG. 10 shows a case in which the sight-line guidance sign VI is moved in accordance with changes in movement speed in the third mode.

In FIG. 10, each of black circles is the sight-line guidance sign VI. In FIG. 10, the plurality of black circles indicates the positions of the sight-line guidance sign VI, each in a unit time period, in the movement from the display start position P2 to the movement end position P3. As shown in FIG. 10, according to changes in movement speed in the third mode, the sight-line guidance sign VI starts moving while linearly accelerating, and the sight-line guidance sign VI ceases moving while linearly decelerating, in the movement from the display start position P2 to the movement end position P3.

A trailer or a fixed object is less likely to make an unpredictable direction change, compared to a pedestrian, a passenger car, a motorcycle, and a bicycle. Regarding a fixed object, in particular, the probability of making an unpredictable direction change is close to zero. Accordingly, it can be said that a trailer or a fixed object is a target 6 to which it is less necessary for the driver U to pay close attention, compared to a pedestrian, a passenger car, a motorcycle, and a bicycle.

Accordingly, when the detected target 6 is a trailer or a fixed object as described above, the display control unit 104 moves the sight-line guidance sign VI in accordance with changes in movement speed in the third mode that is not the first mode or the second mode. Accordingly, the driver U can easily perceive that the sight-line guidance sign VI intends to guide the line of sight to a trailer or a fixed object. Since changes in movement speed in the third mode do not create biological movements, it is more difficult to notice the sight-line guidance sign VI, compared to in the first mode and the second mode. In other words, according to changes in movement speed in the third mode, the driver U is less easily distracted by the sight-line guidance sign VI, compared to in the first mode and the second mode. Accordingly, in guidance of the line of sight to a target 6 to which it is less necessary for the driver U to pay close attention, it is possible to restrain the driver U from being distracted by the sight-line guidance sign VI.

### 1-4-2. Less Than Predetermined Distance

When the display control unit 104 determines that the distance between the display start position P2 and the movement end position P3 in the windshield 3 is less than the predetermined distance, the display control unit 104 moves the sight-line guidance sign VI at a constant speed from the display start position P2 to the movement end position P3.

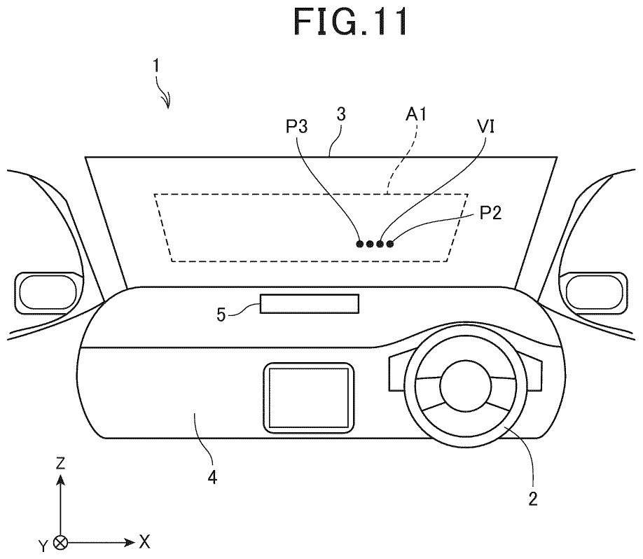

FIG. 11 shows an example of the movement of the sight-line guidance sign VI.

FIG. 11 shows a case in which the sight-line guidance sign VI is moved at a constant speed.

In FIG. 11, each of black circles is the sight-line guidance sign VI. In FIG. 11, the plurality of black circles indicates the positions of the sight-line guidance sign VI, each in a unit time period, in the movement from the display start position P2 to the movement end position P3. As shown in FIG. 11, when it is determined that the distance between the display start position P2 and the movement end position P3 in the windshield 3 is less than the predetermined distance, the sight-line guidance sign VI moves at a constant speed from the display start position P2 to the movement end position P3.

The shorter the distance between the display start position P2 and the movement end position P3 is, the more difficult it is for the driver U to perceive what the mode of changing is even if the movement speed of the sight-line guidance sign VI is changed. Accordingly, when the distance between the display start position P2 and the movement end position P3 is less than the predetermined distance, the sight-line guidance apparatus 7 sets movement speed to a constant speed, regardless of the type of a target 6. In other words, when the distance between the display start position P2 and the movement end position P3 is less than the predetermined distance, the sight-line guidance apparatus 7 does not set changes in the movement speed of the sight-line guidance sign VI to changes according to the type of a target 6. Thus, when it is difficult to perceive what the mode of changing the movement speed of the sight-line guidance sign VI is, it is possible to prevent confusing the driver U.

### 2. Operation of Sight-Line Guidance Apparatus

Next, operation of the sight-line guidance apparatus 7 according to the present embodiment is described.

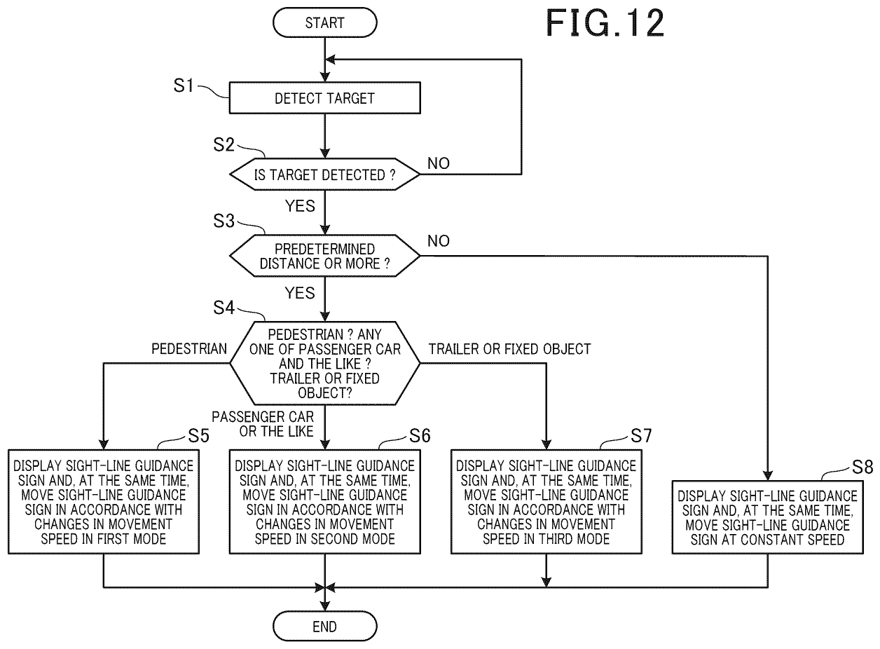

FIG. 12 is a flowchart showing the operation of the sight-line guidance apparatus 7.

The target detection unit 101 detects a target 6 existing in front of the vehicle 1 (step S1).

Step S1 corresponds to “first step”.

The display control unit 104 determines whether or not a target 6 is detected in step S1 (step S2). The determination in step S2 is performed based on whether or not the display control unit 104 receives data from the target detection unit 101.

When the display control unit 104 determines that a target 6 is not detected (step S2: NO), the processor 100 returns the processing to step S1, and the process in step S1 is performed again.

When the display control unit 104 determines that a target 6 is detected (step S2: YES), the display control unit 104 determines whether or not the distance between the display start position P2 and the movement end position P3 is a predetermined distance or more (step S3).

When the display control unit 104 determines that the distance between the display start position P2 and the movement end position P3 is the predetermined distance or more (step S3: YES), the display control unit 104 determines whether the detected target 6 is a pedestrian, is any one of a passenger car and the like, or is a trailer or a fixed object (step S4).

When the display control unit 104 determines that the detected target 6 is a pedestrian (step S4: PEDESTRIAN), the display control unit 104 displays the sight-line guidance sign VI and, at the same time, moves the sight-line guidance sign VI in accordance with changes in movement speed in the first mode (step S5).

Step S5 corresponds to “second step”.

Returning to the description of step S4, when the display control unit 104 determines that the detected target 6 is any one of a passenger car and the like (step S4: PASSENGER CAR OR THE LIKE), the display control unit 104 displays the sight-line guidance sign VI and, at the same time, moves the sight-line guidance sign VI in accordance with changes in movement speed in the second mode (step S6).

Step S6 corresponds to “second step”.

Returning to the description of step S4, when the display control unit 104 determines that the detected target 6 is a trailer or a fixed object (step S4: TRAILER OR FIXED OBJECT), the display control unit 104 displays the sight-line guidance sign VI and, at the same time, moves the sight-line guidance sign VI in accordance with changes in movement speed in the third mode (step S7).

Step S7 corresponds to “second step”.

Returning to the description of step S3, when the display control unit 104 determines that the distance between the display start position P2 and the movement end position P3 is less than the predetermined distance (step S3: NO), the display control unit 104 displays the sight-line guidance sign VI and, at the same time, moves the sight-line guidance sign VI at a constant speed (step S8).

Step S8 corresponds to “second step”.

### 3. Other Embodiments

The embodiment described above illustrates only an aspect, and any modifications and applications can be made.

Although the vehicle 1 that is a four-wheel automobile is illustrated as “vehicle” in the embodiment, the number of wheels is not limited to four as long as the “vehicle”includes a windshield 3.

The embodiment described above illustrates a case in which the “first mode” is 1/f fluctuation, illustrates a case in which the “second mode” is a mode with a minimum jerk, and illustrates a case in which the “third mode” is a mode of linearly accelerating and then linearly decelerating. However, the “first mode” is not limited to 1/f fluctuation, and may be any mode other than the “second mode” and the “third mode”. However, it is preferable that the “first mode” be a mode in which humans more easily notice the sight-line guidance sign VI than in the “second mode” and the “third mode”. The “second mode” is not limited to the mode with a minimum jerk, and may be any mode other than the “first mode” and the “third mode”. However, it is preferable that the “second mode” be a mode in which humans more easily notice the sight-line guidance sign VI than in at least the “third mode”. The “third mode” is not limited to the mode of linearly accelerating and then linearly decelerating, and may be any mode other than the “first mode” and the “second mode”. However, if the “first mode” and the “second mode” are modes that create biological movements, it is preferable that the “third mode” be a mode that does not create biological movements.

In the embodiment, a configuration is made such that the HUD 5 is used to display the sight-line guidance sign VI on the windshield 3. However, means for displaying the sight-line guidance sign VI may be any means for displaying a virtual image on the windshield 3, not limited to the HUD 5, and may be, for example, an LED (Light Emitting Diode) or other display means.

The processor 100 may be configured by using a plurality of processors, or may be configured by using a single processor. The processor 100 may be hardware programmed to implement the functional units described above. In such a case, the processor 100 is configured by using, for example, an ASIC (Application Specific Integrated Circuit) or an FPGA (Field Programmable Gate Array).

The configuration as to each unit of the vehicle 1 shown in FIG. 2 is an example, and a specific implementation form is not limited particularly. In other words, an individual corresponding hardware piece does not necessarily need to be mounted for each unit, and it is also certainly possible to make a configuration such that the function of each unit is implemented by a single processor executing a program. In the embodiment, one or some of the functions implemented by using software may be configured as hardware, or alternatively, one or some of the functions implemented by hardware may be implemented by using software.

Furthermore, the step units of operation shown in FIG. 12 are created by division according to main processes, and the present invention is not limited by a way of division into, or by names of, units of processing. The operation may be divided into more step units according to processes. A step unit may be divided to include more sub-processes. The order of steps may be interchanged as appropriate to the extent that the gist of the present invention is not impaired.

When a sight-line guidance method by the sight-line guidance apparatus 7 is implemented by using the processor 100, the program to be executed by the processor 100 can also be configured in the form of a recording medium or a transmission medium transmitting the program. In other words, the control program 111 can also be implemented in a state in which the control program 111 is recorded on a removable information recording medium. Examples of the information recording medium include magnetic recording media such as hard disk, optical recording media such as CD, and semiconductor storage devices such as USB (Universal Serial Bus) memory and SSD (Solid State Drive). Any other recording medium can also be used.

### 4. Configurations Supported by the Embodiment

The embodiment supports following configurations.

### Configuration 1

A sight-line guidance apparatus that guides a line of sight of a driver of a vehicle, including: a detection unit that detects a target existing in front of the vehicle; and a display control unit that displays a sight-line guidance sign on a windshield of the vehicle when the detection unit detects the target, the sight-line guidance sign guiding the line of sight of the driver to the target, wherein the display control unit displays the sight-line guidance sign in such a manner that the sight-line guidance sign moves from a display start position of the sight-line guidance sign toward the target in accordance with a change in movement speed, the change being made according to a type of the target.

According to the sight-line guidance apparatus in configuration 1, changes in the movement speed of the sight-line guidance sign can be varied according to the type of a target. Accordingly, the driver can perceive, not only from a result of movement of the sight-line guidance sign but also from changes in the movement speed of the sight-line guidance sign, what target the line of sight is intended to be guided to. Accordingly, the driver can easily perceive what target the line of sight is intended to be guided to. Moreover, since the driver can perceive, from changes in the movement speed of the sight-line guidance sign, what target the line of sight is intended to be guided to, the driver can quickly perceive what target the line of sight is intended to be guided to.

### Configuration 2

The sight-line guidance apparatus according to configuration 1, wherein when the type of the target is pedestrian, the display control unit displays the sight-line guidance sign in accordance with a change in movement speed in a first mode.

According to the sight-line guidance apparatus in configuration 2, the sight-line guidance sign can be moved in accordance with changes in movement speed according to the fact that the target is a pedestrian.

Accordingly, the driver can easily perceive that the line of sight is intended to be guided to a pedestrian.

### Configuration 3

The sight-line guidance apparatus according to configuration 2, wherein the first mode is 1/f fluctuation.

According to the sight-line guidance apparatus in configuration 3, the sight-line guidance sign can be moved in accordance with changes in movement speed in a mode in which humans easily notice the movement.

Accordingly, the driver can easily perceive that the line of sight is intended to be guided to a pedestrian, and the probability can be enhanced that the driver directs the line of sight to the pedestrian due to the sight-line guidance sign.

### Configuration 4

The sight-line guidance apparatus according to any one of configurations 1 to 3, wherein when the type of the target is any one of passenger car, motorcycle, and bicycle, the display control unit displays the sight-line guidance sign in accordance with a change in movement speed in a second mode.

According to the sight-line guidance apparatus in configuration 4, the sight-line guidance sign can be moved in accordance with changes in movement speed according to the fact that the target is any one of a passenger car, a motorcycle, and a bicycle. Accordingly, the driver can easily perceive that the line of sight is intended to be guided to the target that is any one of a passenger car, a motorcycle, and a bicycle.

### Configuration 5

The sight-line guidance apparatus according to configuration 4, wherein the second mode is a mode with a minimum jerk.

According to the sight-line guidance apparatus in configuration 5, the sight-line guidance sign can be moved in accordance with changes in movement speed in a mode in which humans easily notice the movement. Accordingly, the driver can easily perceive that the line of sight is intended to be guided to the target that is any one of a passenger car, a motorcycle, and a bicycle, and the probability can be enhanced that the driver directs the line of sight to the target due to the sight-line guidance sign.

### Configuration 6

The sight-line guidance apparatus according to any one of configurations 1 to 5, wherein when the type of the target is trailer or fixed object, the display control unit displays the sight-line guidance sign in accordance with a change in movement speed in a third mode.

According to the sight-line guidance apparatus in configuration 6, the sight-line guidance sign can be moved in accordance with changes in movement speed according to the fact that the target is a trailer or a fixed object. Accordingly, the driver can easily perceive that the line of sight is intended to be guided to a trailer or a fixed object.

### Configuration 7

The sight-line guidance apparatus according to configuration 6, wherein the third mode is a mode of linearly accelerating and then linearly decelerating.

According to the sight-line guidance apparatus in configuration 7, by displaying the sight-line guidance sign in a mode that does not create biological movements, the driver is less easily distracted by the sight-line guidance sign. Accordingly, in guidance of the line of sight to a target to which it is less necessary for the driver to pay close attention, it is possible to restrain the driver from being distracted by the sight-line guidance sign.

### Configuration 8

The sight-line guidance apparatus according to any one of configurations 1 to 7, wherein when a distance over which the sight-line guidance sign is to be moved is a predetermined distance or more, the display control unit changes the movement speed of the sight-line guidance sign.

According to the sight-line guidance apparatus in configuration 8, since the movement speed of the sight-line guidance sign is changed when it is easy to perceive changes in movement speed, the driver can correctly and easily perceive what target the line of sight is intended to be guided to.

### Configuration 9

The sight-line guidance apparatus according to configuration 8, wherein when the distance over which the sight-line guidance sign is to be moved is less than the predetermined distance, the display control unit moves the sight-line guidance sign at a constant speed.

According to the sight-line guidance apparatus in configuration 9, when it is difficult to perceive what the mode of changing the movement speed of the sight-line guidance sign is, it is possible to prevent confusing the driver.

### Configuration 10

A sight-line guidance method of guiding a line of sight of a driver of a vehicle, including: a first step of detecting a target existing in front of the vehicle; and a second step of displaying a sight-line guidance sign on a windshield of the vehicle when the target is detected in the first step, the sight-line guidance sign guiding the line of sight of the driver to the target, wherein the second step displays the sight-line guidance sign in such a manner that the sight-line guidance sign moves from a display start position of the sight-line guidance sign toward the target in accordance with a change in movement speed, the change being made according to a type of the target.

According to the sight-line guidance method in configuration 10, similar effects to those of the sight-line guidance apparatus in configuration 1 can be brought about.

### Configuration 11

A non-transitory computer readable recording medium recording a program for a sight-line guidance apparatus that guides a line of sight of a driver of a vehicle, the program causing a processor of the sight-line guidance apparatus to function as: a detection unit that detects a target existing in front of the vehicle; and a display control unit that displays a sight-line guidance sign on a windshield of the vehicle when the detection unit detects the target, the sight-line guidance sign guiding the line of sight of the driver to the target, wherein the display control unit displays the sight-line guidance sign in such a manner that the sight-line guidance sign moves from a display start position of the sight-line guidance sign toward the target in accordance with a change in movement speed, the change being made according to a type of the target.

According to the recording medium in configuration 11, similar effects to those of the sight-line guidance apparatus in configuration 1 can be brought about.

### REFERENCE SIGNS LIST

1 vehicle
2 steering wheel
3 windshield
4 instrument panel
5 HUD
6 target
7 sight-line guidance apparatus
8 front camera
9 driver monitoring camera
10 position detection device
100 processor
101 target detection unit
102 sight-line detection unit
103 head detection unit
104 display control unit
110 memory
111 control program (program)
GF1 graph
GF2 graph
GF3 graph
HD head
L1 predetermined distance
L2 line
P1 sight-line position
P2 display start position
P3 movement end position
P3-1 first movement end position
P3-2 second movement end position
P4 position
S1 step (first step)
S2 to S4 step
S5 to S8 step (second step)
SG captured image
U driver
VI sight-line guidance sign

1. A sight-line guidance apparatus that guides a line of sight of a driver of a vehicle, comprising:
a detection unit that detects a target existing in front of the vehicle; and
a display control unit that displays a sight-line guidance sign on a windshield of the vehicle when the detection unit detects the target, the sight-line guidance sign guiding the line of sight of the driver to the target,
wherein the display control unit displays the sight-line guidance sign in such a manner that the sight-line guidance sign moves from a display start position of the sight-line guidance sign toward the target in accordance with a change in movement speed, the change being made according to a type of the target.

2. The sight-line guidance apparatus according to claim 1, wherein when the type of the target is pedestrian, the display control unit displays the sight-line guidance sign in accordance with a change in movement speed in a first mode.

3. The sight-line guidance apparatus according to claim 2, wherein the first mode is 1/f fluctuation.

4. The sight-line guidance apparatus according to claim 1, wherein when the type of the target is any one of passenger car, motorcycle, and bicycle, the display control unit displays the sight-line guidance sign in accordance with a change in movement speed in a second mode.

5. The sight-line guidance apparatus according to claim 4, wherein the second mode is a mode with a minimum jerk.

6. The sight-line guidance apparatus according to claim 1, wherein when the type of the target is trailer or fixed object, the display control unit displays the sight-line guidance sign in accordance with a change in movement speed in a third mode.

7. The sight-line guidance apparatus according to claim 6, wherein the third mode is a mode of linearly accelerating and then linearly decelerating.

8. The sight-line guidance apparatus according to claim 1, wherein when a distance over which the sight-line guidance sign is to be moved is a predetermined distance or more, the display control unit changes the movement speed of the sight-line guidance sign.

9. The sight-line guidance apparatus according to claim 8, wherein when the distance over which the sight-line guidance sign is to be moved is less than the predetermined distance, the display control unit moves the sight-line guidance sign at a constant speed.

10. A sight-line guidance method of guiding a line of sight of a driver of a vehicle, comprising:
a first step of detecting a target existing in front of the vehicle; and
a second step of displaying a sight-line guidance sign on a windshield of the vehicle when the target is detected in the first step, the sight-line guidance sign guiding the line of sight of the driver to the target,
wherein the second step displays the sight-line guidance sign in such a manner that the sight-line guidance sign moves from a display start position of the sight-line guidance sign toward the target in accordance with a change in movement speed, the change being made according to a type of the target.

11. A non-transitory computer readable recording medium recording a program for a sight-line guidance apparatus that guides a line of sight of a driver of a vehicle, the program causing a processor of the sight-line guidance apparatus to function as:
a detection unit that detects a target existing in front of the vehicle; and
a display control unit that displays a sight-line guidance sign on a windshield of the vehicle when the detection unit detects the target, the sight-line guidance sign guiding the line of sight of the driver to the target,
wherein the display control unit displays the sight-line guidance sign in such a manner that the sight-line guidance sign moves from a display start position of the sight-line guidance sign toward the target in accordance with a change in movement speed, the change being made according to a type of the target.
